(19) United States
(12) Patent Application Publication
(10) Pub. No.: US 2025/0362683 A1
(43) Pub. Date: Nov. 27, 2025

(54) FLIGHT PATH GENERATION SYSTEM, UNMANNED AERIAL VEHICLE, AND FLIGHT PATH GENERATION METHOD

(71) Applicant: Kubota Corporation, Osaka (JP)

(72) Inventor: Kohei SEINO, Sakai-shi (JP)

(21) Appl. No.: 19/291,920

(22) Filed: Aug. 6, 2025

Related U.S. Application Data
(63) Continuation of application No. PCT/JP2023/004972, filed on Feb. 14, 2023.

(51) Int. Cl. G05D 1/46; B64U 10/14; G05D 109/25

(52) U.S. Cl. CPC G05D 1/46; B64U 10/14; B64U 2201/10; B64U 2201/20; G05D 2109/254

(57) ABSTRACT

A flight path generation system for generating a three-dimensional flight path for an unmanned aerial vehicle includes an acquisition device to acquire route data including information of a two-dimensional flight path of the unmanned aerial vehicle and map data including information of elevation at each point on the two-dimensional flight path, and a processor configured or programmed to generate the three-dimensional flight path by determining a flight altitude of the unmanned aerial vehicle from a ground on the two-dimensional flight path based on the two-dimensional flight path and the elevation. The processor is configured or programmed to determine the flight altitude in an excess region with an altitude not exceeding a first altitude and a first region with an altitude not exceeding the first altitude, such that a maximum value of the flight altitude of the unmanned aerial vehicle in the excess region does not exceed the first altitude.

### CROSS REFERENCE TO RELATED APPLICATIONS

This application is a Continuation Application of PCT Application No. PCT/JP2023/004972 filed on Feb. 14, 2023. The entire contents of this application are hereby incorporated herein by reference.

### BACKGROUND OF THE INVENTION

### 1. Field of the Invention

The present disclosure relates to flight path generation systems, unmanned aerial vehicles and flight path generation methods.

### 2. Description of the Related Art

An unmanned aerial vehicle (UAV) is an aircraft that structurally cannot accommodate human occupants and is capable of flight through remote control or autonomous operation. A rotary-wing type unmanned aerial vehicle is a UAV that generates lift using propellers, namely rotary wings, which rotate around an axis. A small unmanned aerial vehicle including multiple rotary wings (Multi-Rotor UAV) is also called a “drone”, “multirotor”, or “multicopter”, and is widely used for applications including aerial photography, surveying, logistics, and agricultural spraying.

Japanese Patent Application Publication No. 2022-104737 describes an unmanned aerial vehicle (unmanned flying body) that changes its flight position in coordination with the operation of an agricultural machine.

### SUMMARY OF THE INVENTION

There is a demand for efficient control of unmanned aerial vehicle flight. For example, there is a demand for further improvement in methods and systems for generating flight paths for unmanned aerial vehicles.

Example embodiments of the present disclosure provide unmanned aerial vehicles, flight path generation systems, and flight path generation methods capable of efficiently controlling flight.

In a non-limiting example embodiment, a flight path generation system according to an example embodiment of the present disclosure is a system for generating a three-dimensional flight path for an unmanned aerial vehicle including an acquisition device configured or programmed to acquire route data including information of a two-dimensional flight path of the unmanned aerial vehicle and map data including information of elevation at each point on the two-dimensional flight path, and a processor configured or programmed to generate the three-dimensional flight path by determining a flight altitude of the unmanned aerial vehicle from the ground on the two-dimensional flight path based on the two-dimensional flight path and the elevation, wherein, under an assumption that the two-dimensional flight path is traveled by the unmanned aerial vehicle moving horizontally, if an excess region where the flight altitude exceeds a predetermined first altitude and a first region where the flight altitude does not exceed the first predetermined altitude occur on the two-dimensional flight path, the first region leading to the excess region, the processor is configured or programmed to determine the flight altitude in the excess region and the first region such that (i) a maximum value of the flight altitude of the unmanned aerial vehicle in the excess region does not exceed the first predetermined altitude, (ii) the unmanned aerial vehicle descends in a descent region including a portion of the excess region or the first region, and (iii) the unmanned aerial vehicle moves horizontally over regions other than the descent region in the excess region and the first region.

In a non-limiting example embodiment, a flight path generation method according to an example embodiment of the present disclosure is a method for generating a three-dimensional flight path for an unmanned aerial vehicle including acquiring route data including information of a two-dimensional flight path of the unmanned aerial vehicle and map data including information of elevation at each point on the two-dimensional flight path, and determining a flight altitude of the unmanned aerial vehicle from the ground on the two-dimensional flight path based on the two-dimensional flight path and the elevation, wherein the determining the flight altitude includes, under an assumption that the two-dimensional flight path is traveled by the unmanned aerial vehicle moving horizontally, if an excess region where the flight altitude exceeds a predetermined first altitude and a first region where the flight altitude does not exceed the first predetermined altitude occur on the two-dimensional flight path, the first region leading to the excess region, determining the flight altitude in the excess region and the first region such that (i) a maximum value of the flight altitude of the unmanned aerial vehicle in the excess region does not exceed the first predetermined altitude, (ii) the unmanned aerial vehicle descends in a descent region including a portion of the excess region or the first region, and (iii) the unmanned aerial vehicle moves horizontally over regions other than the descent region in the excess region and the first region.

According to example embodiments of unmanned aerial vehicles, flight path generation systems, and flight path generation methods of the present disclosure, the flight of an unmanned aerial vehicle can be controlled efficiently.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1A is a block diagram schematically showing several examples of rotation drivers for rotating rotors in an unmanned aerial vehicle including a plurality of rotors.

FIG. 1B is a plan view schematically showing one example of a basic configuration of an unmanned aerial vehicle including a plurality of rotors.

FIG. 1C is a side view schematically showing one example of a basic configuration of an unmanned aerial vehicle including a plurality of rotors.

FIG. 1D is a plan view schematically showing another example of a basic configuration of an unmanned aerial vehicle including a plurality of rotors.

FIG. 2A is a block diagram showing a basic configuration example of a battery-driven multicopter.

FIG. 2B is a block diagram showing a basic configuration example of a series hybrid type multicopter.

FIG. 2C is a block diagram showing a basic configuration example of a parallel hybrid type multicopter.

FIG. 3A is a plan view schematically showing an example of a multicopter flight path on a two-dimensional map.

FIG. 3B is a diagram schematically showing an example of a multicopter flying along a flight path.

FIG. 3C is a diagram schematically showing another example of a multicopter flying along a flight path.

FIG. 4A is a diagram schematically showing an example of a multicopter flying along a flight path using the flight path generation system according to an example embodiment.

FIG. 4B is a diagram schematically showing another example of a multicopter flying along a flight path using the flight path generation system according to an example embodiment.

FIG. 4C is a diagram schematically showing another example of a multicopter flying along a flight path using the flight path generation system according to an example embodiment.

FIG. 4D is a diagram schematically showing another example of a multicopter flying along a flight path using the flight path generation system according to an example embodiment.

FIG. 4E is a diagram schematically showing another example of a multicopter flying along a flight path using the flight path generation system according to an example embodiment.

FIG. 4F is a diagram schematically showing another example of a multicopter flying along a flight path using the flight path generation system according to an example embodiment.

FIG. 5A is a diagram schematically showing an example of a flight path on a two-dimensional map.

FIG. 5B is a diagram schematically showing vertical movement of a multicopter when flying along a flight path.

FIG. 5C is a diagram schematically showing vertical movement of a multicopter when flying along a flight path.

FIG. 6 is a block diagram showing an example of hardware configuration of a controller.

FIG. 7 is a diagram schematically showing an example of a communication network to which a multicopter is connected.

### DETAILED DESCRIPTION OF THE EXAMPLE EMBODIMENTS

An unmanned aerial vehicle including a plurality of rotors includes a rotation driver to rotate the rotors (hereinafter referred to as “propellers”). Hereinafter, such an unmanned aerial vehicle is referred to as a “multicopter”.

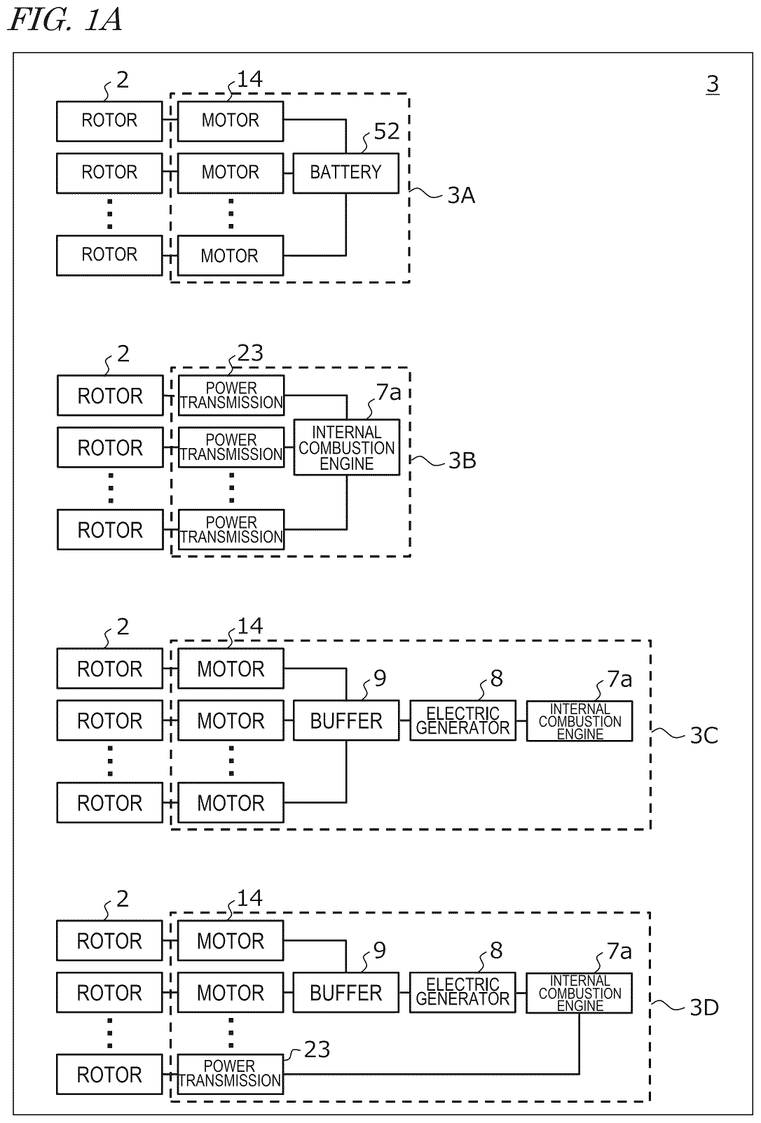

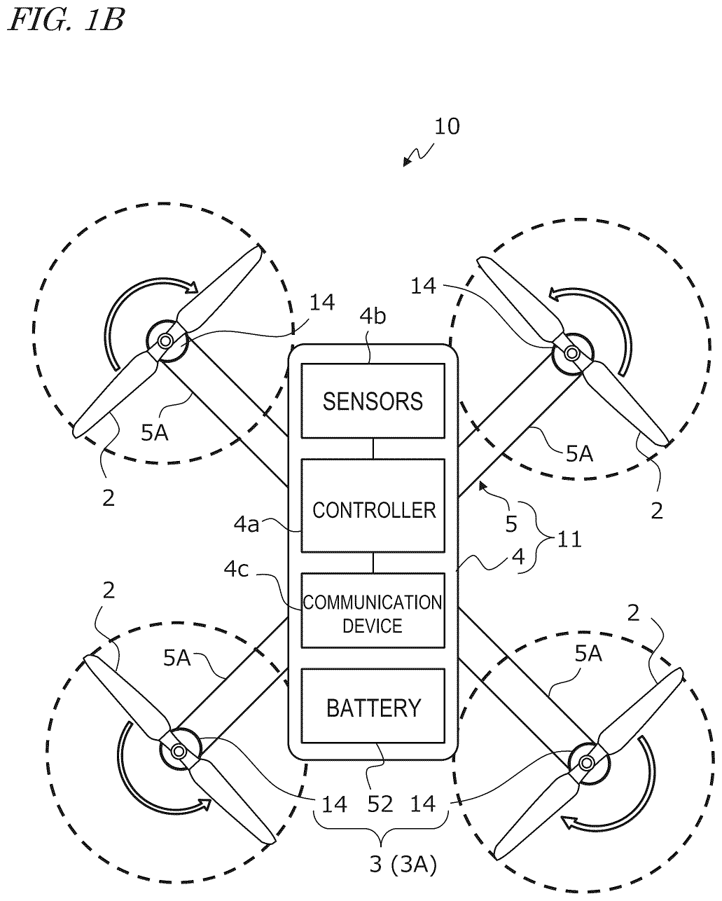

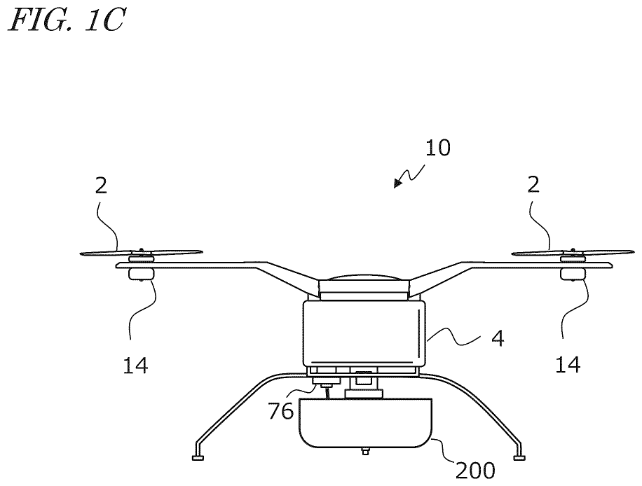

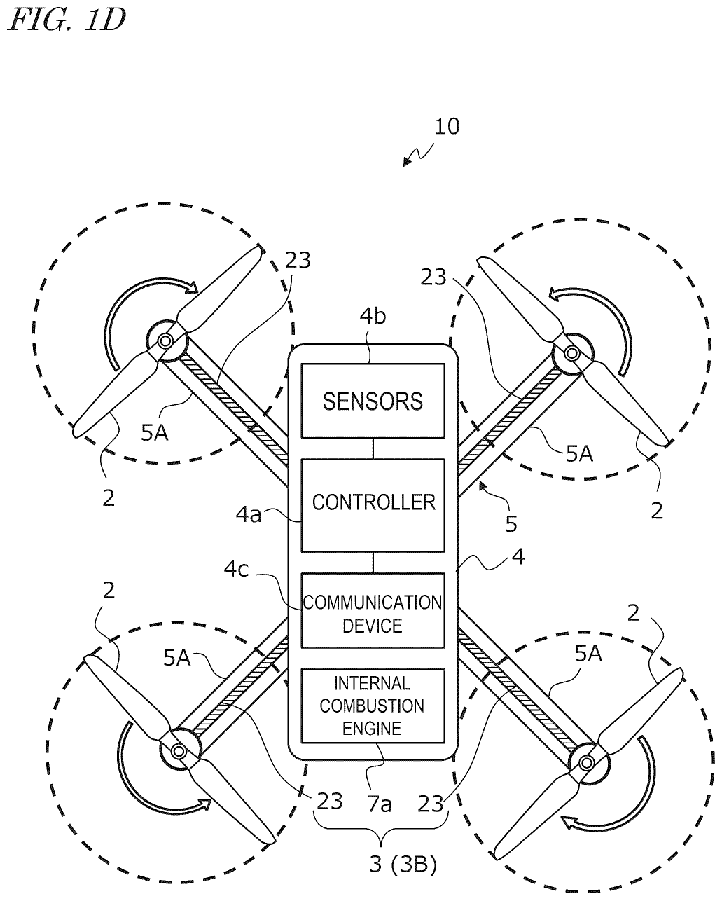

The configuration of rotation drivers included in multicopters may take various forms. FIG. 1A is a schematic block diagram showing four examples of rotation driver 3 in the present disclosure.

The first rotation driver 3A shown in FIG. 1A includes a plurality of electric motors (hereinafter referred to as “motors”) 14 that rotate a plurality of rotors 2, and a battery 52 that stores electric power to be supplied to each motor 14. The battery 52 is, for example, a secondary battery such as a polymer-type lithium-ion battery. Each rotor 2 is connected to the output shaft of its corresponding motor 14 and is rotated by the motor 14. To increase payload and/or flight duration, it is necessary to increase the power storage capacity of battery 52. While the power storage capacity of battery 52 can be increased by making battery 52 larger, enlarging battery 52 leads to an increase in weight.

The second rotation driver 3B shown in FIG. 1A includes a power transmission system 23 mechanically connected to rotor 2, and an internal combustion engine 7a that provides driving force (torque) to power transmission system 23. The power transmission system 23 includes mechanical components such as gears or belts and transmits torque from the output shaft of internal combustion engine 7a to rotor 2. The internal combustion engine 7a can efficiently generate mechanical energy through fuel combustion. Examples of internal combustion engine 7a may include gasoline engines, diesel engines, and hydrogen engines. Additionally, the number of internal combustion engines 7a included in rotation driver 3B is not limited to one.

The third rotation driver 3C shown in FIG. 1A includes a plurality of motors 14, a power buffer 9 that stores electric power to be supplied to each motor 14, an electric generator 8 such as an alternator that generates electric power, and an internal combustion engine 7a that provides mechanical energy for power generation to the electric generator 8. While a typical example of power buffer 9 is a battery such as a secondary battery, it may also be a capacitor. In the third rotation driver 3C, even when the power buffer 9 does not have a large power storage capacity, it is possible to increase payload and/or flight duration because the electric generator 8 generates electric power using the driving force (mechanical energy) of internal combustion engine 7a. This type of drive is called “series hybrid drive”. The electric generator 8 and internal combustion engine 7a in series hybrid drive are called a “range extender” as they extend the flight distance of the multicopter.

The fourth rotation driver 3D shown in FIG. 1A includes a plurality of motors 14, a power buffer 9 that stores electric power to be supplied to each motor 14, an electric generator 8 such as an alternator that generates electric power, an internal combustion engine 7a that provides driving force to the electric generator 8 for power generation, a power transmission system 23 that transmits driving force generated by the internal combustion engine 7a to the rotor 2 to rotate the rotor 2. At least one rotor 2 of the plurality of rotors 2 is rotated by the internal combustion engine 7a, while other rotors 2 are rotated by the motor 14. In the fourth rotation driver 3D, since mechanical energy generated by internal combustion engine 7a can be utilized for rotor rotation without conversion to electrical energy, energy utilization efficiency can be enhanced. This type of drive is called “parallel hybrid drive”.

FIG. 1B is a plan view schematically showing a basic configuration example of multicopter 10. In the configuration example of FIG. 1B, a rotation driver 3 includes the first rotation driver 3A shown in FIG. 1A. That is, in this example, rotation driver 3 (3A) includes motors 14 and a battery 52. FIG. 1C is a side view schematically showing the multicopter 10.

A multicopter 10 shown in FIGS. 1B and 1C includes a plurality of rotors 2, a main body 4, and a body frame 5 that supports rotors 2 and main body 4. The body frame 5 supports the main body 4 at its central portion and supports the plurality of rotors 2 rotatably at the plurality of arms 5A extending outward from the central portion. The motors 14 that rotate rotors 2 are provided near the ends of each arm 5A. The main body 4 and body frame 5 may be collectively referred to as “body 11”.

In the example of FIG. 1B, the multicopter 10 is a quad-type multicopter (quadcopter) including four rotors 2. The rotors 2 positioned on the same diagonal line rotate in the same direction (clockwise or counterclockwise), while rotors 2 positioned on different diagonal lines rotate in opposite directions.

The main body 4 includes a controller 4a configured or programmed to control the operation of devices and components mounted on multicopter 10, sensors 4b connected to the controller 4a, a communication device 4c connected to the controller 4a, and a battery 52.

The controller 4a may be configured or programmed to include, for example, a flight controller such as a flight controller and a higher-level computer (companion computer). The companion computer may be configured or programmed to perform advanced computational processing such as image processing, obstacle detection, and obstacle avoidance based on sensor data acquired by the sensors 4b.

The sensors 4b may include an acceleration sensor, angular velocity sensor, geomagnetic sensor, atmospheric pressure sensor, altitude sensor, temperature sensor, flow sensor, imaging device, laser sensor, ultrasonic sensor, obstacle contact sensor, and GNSS (Global Navigation Satellite System) receiver. The acceleration sensor and angular velocity sensor may be mounted on the main body 4 as components of an IMU (Inertial Measurement Unit). Examples of laser sensors may include a laser range finder used to measure distance to the ground, and 2D or 3D LiDAR (light detection and ranging).

The communication device 4c may include a wireless communication module for signal transmission and reception with a ground-based transmitter or ground control station (GCS) via an antenna, and a mobile communication module that utilizes cellular communication networks. The communication device 4c is configured or programmed to receive signals such as control commands transmitted from the ground and transmit sensor data such as image data acquired by sensors 4b as telemetry information. The communication device 4c may also include functions for communication between multicopters and satellite communication capabilities. The controller 4a may be configured or programmed to connect to computers in the cloud through the communication device 4c. The computer in the cloud may be configured or programmed to execute some or all of the functions of the companion computer.

A battery 52 is a secondary battery that is configured to store electric power through charging and supply electric power to motors 14 through discharging. Through the operation of battery 52 and the plurality of motors 14, a plurality of rotors 2 can be rotationally driven to generate desired thrust.

Each of the plurality of rotors 2 generally includes a plurality of blades with fixed pitch angles and generates thrust through rotation. The pitch angles may be variable. Not all of the plurality of rotors 2 need to have the same diameter (propeller diameter), and one or more rotors 2 may have a larger diameter than other rotors 2. The thrust (static thrust) generated by rotating the rotor 2 is generally proportional to the cube of the rotor's diameter. Therefore, when the rotors 2 of different diameters are provided, the rotors 2 with relatively large diameters may be called “main rotors” and the rotors 2 with relatively small diameters may be called “sub-rotors”. Regardless of the size of the diameter, the rotors 2 capable of generating relatively large thrust and the rotors 2 capable of generating relatively small thrust may be included depending on the configuration of rotation driver 3. In such case, the rotors 2 capable of generating relatively large thrust may be called “main rotors” and the rotors 2 capable of generating relatively small thrust may be called “sub-rotors”. For example, the rotors 2 that generate relatively large thrust per rotation may be called “main rotors” and the rotors 2 that generate relatively small thrust per rotation may be called “sub-rotors”. In one example, main rotors may be positioned more inward than sub-rotors. In other words, the rotors 2 may be positioned such that the distance from the center of the body to the rotation axis of each main rotor is shorter than the distance from the center to the rotation axis of each sub-rotor.

In this example, the rotation driver 3 includes a plurality of motors 14. As mentioned above, the rotation driver 3 may include the internal combustion engine 7a.

FIG. 1D is a plan view schematically showing a basic configuration example of a multicopter 10 including the second rotation driver 3B. In the example shown in FIG. 1D, the internal combustion engine 7a is supported by the main body 4. In this example, the driving force generated by internal combustion engine 7a is transmitted to the plurality of rotors 2 through a plurality of power transmission systems 23 to rotate each rotor 2. The controller 4a may be configured or programmed to change the rotational speed of individual rotors 2 by controlling each power transmission system 23. Rotation driver 3B may include a mechanism to change the pitch angle of blades of each of the plurality of rotors 2. In that case, the controller 4a may be configured or programmed to adjust the lift generated by each rotor 2 by controlling that mechanism to change the blade pitch angles.

In a “parallel hybrid drive” where some of the plurality of rotors 2 are rotated by the internal combustion engine 7a and other rotors 2 are rotated by the motors 14, the internal combustion engine 7a and battery 52 are supported by the main body 4. At least one of the plurality of rotors 2 is connected to the internal combustion engine 7a through the power transmission system 23, and other rotors 2 are connected to the motors 14.

In such a parallel hybrid drive, the diameter of one or more rotors 2 rotated by the internal combustion engine 7a may be larger than the diameter of other rotors 2 rotated by the motors 14. In other words, the internal combustion engine 7a may be used to rotate the main rotors and the motors 14 may be used to rotate the sub-rotors. In such case, the main rotors are mainly used to generate thrust, and the sub-rotors are used to both generate thrust and attitude control. The main rotors may be called “booster rotors” and the sub-rotors may be called “attitude control rotors”.

In the parallel hybrid drive, the internal combustion engine is used for both thrust generation and power generation. By selectively transmitting driving force (torque) generated by the internal combustion engine to either or both of the rotor and electric generator, it is possible to achieve balanced thrust generation and power generation.

When a multicopter includes an internal combustion engine and uses the internal combustion engine for at least one of thrust generation and power generation, this contributes to increased payload and flight duration. It is desirable to perform attitude control of the multicopter by rotating propellers using motors, which have superior response characteristics compared to internal combustion engines. Therefore, in applications where accurate attitude control of the multicopter is required, it is desirable to adopt parallel hybrid drive or series hybrid drive to increase payload and flight duration. Note that when the rotation driver 3 includes a mechanism to change the pitch angle of blades of each of the plurality of the rotors 2, the attitude can also be adjusted by changing the pitch angle of each blade.

Through increased payload and flight duration, the applications of multicopters can be further expanded. For example, in the agricultural field, multicopters are currently being used for agricultural chemical spraying or crop growth monitoring. Various agricultural work can be performed from the air by connecting various ground work machines (hereinafter may be simply referred to as “work machines”) to the multicopter. Agricultural work machines are sometimes referred to as “implements”. Examples of implements may include sprayers for spraying chemicals on crops, mowers, seeders, spreaders (fertilizer applicators), rakes, balers, harvesters, plows, harrows, or rotary tillers. Work vehicles such as tractors are not included in “implements” in this disclosure.

In the example shown in FIG. 1C, an implement 200 capable of dispersing substances such as agricultural chemicals or fertilizers onto a field or crops in the field is connected to multicopter 10. Increased payload and flight duration enable the implement 200 to achieve a larger size and/or multi-functionality. For example, by changing the implement 200 connected to multicopter 10, various ground operations (agricultural work) including liquid application, granular application, fertilization, thinning, weeding, transplanting, direct seeding, and harvesting can be performed. The implement 200 may include mechanisms such as robotic hands. In that case, a single implement 200 can perform various ground operations. When the implement 200 includes space large enough to store materials, the implement 200 can also transport agricultural materials or harvested crops over a wide area. There are various forms of connecting the implement 200 to the multicopter 10. The multicopter 10 may suspend and tow the implement 200 using a cable. The implement 200 towed by the multicopter 10 can perform ground operations while being towed during flight or hovering of multicopter 10. The implement 200 during operation may be in the air or on the ground.

In the example shown in FIG. 1C, the multicopter 10 includes power supply 76. The power supply 76 is a device that supplies power to the implement 200 from driving energy sources such as a battery 52 or an electric generator 8 included in the multicopter 10. Various functions of the implement 200 may be performed using this power. The implement 200 includes actuators such as motors that operate using power obtained from the power supply 76 of the multicopter 10. The implement 200 preferably includes a battery to store power.

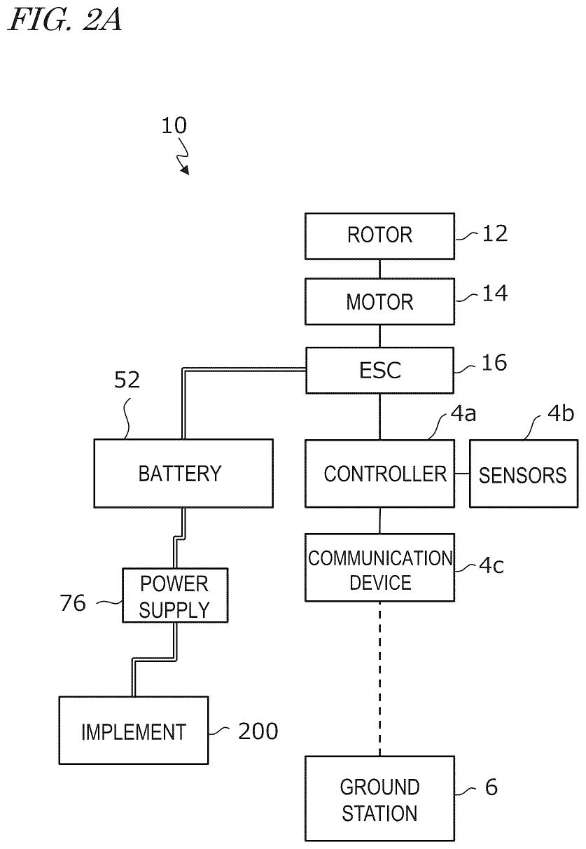

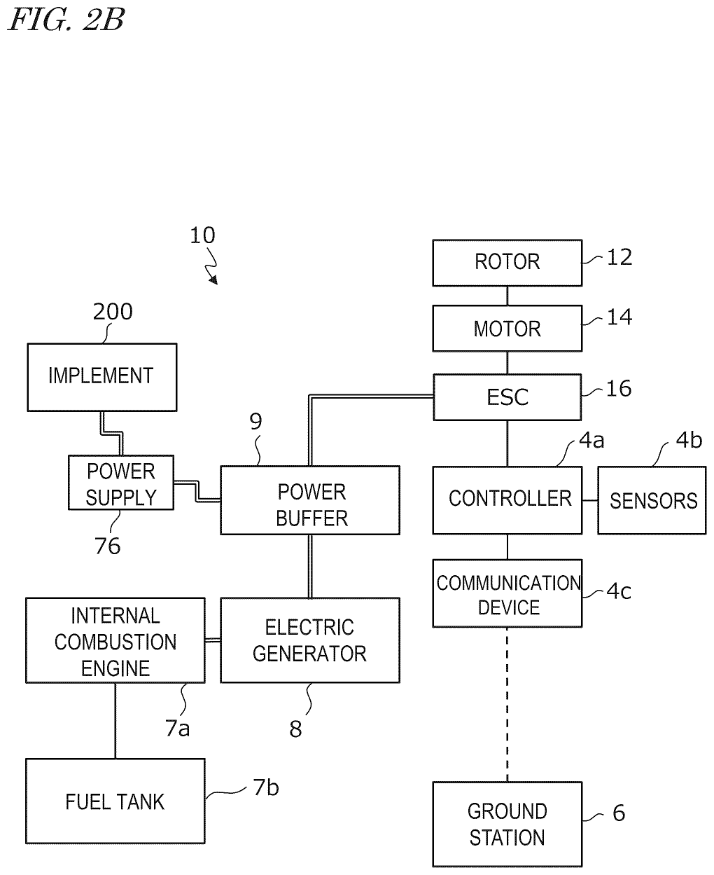

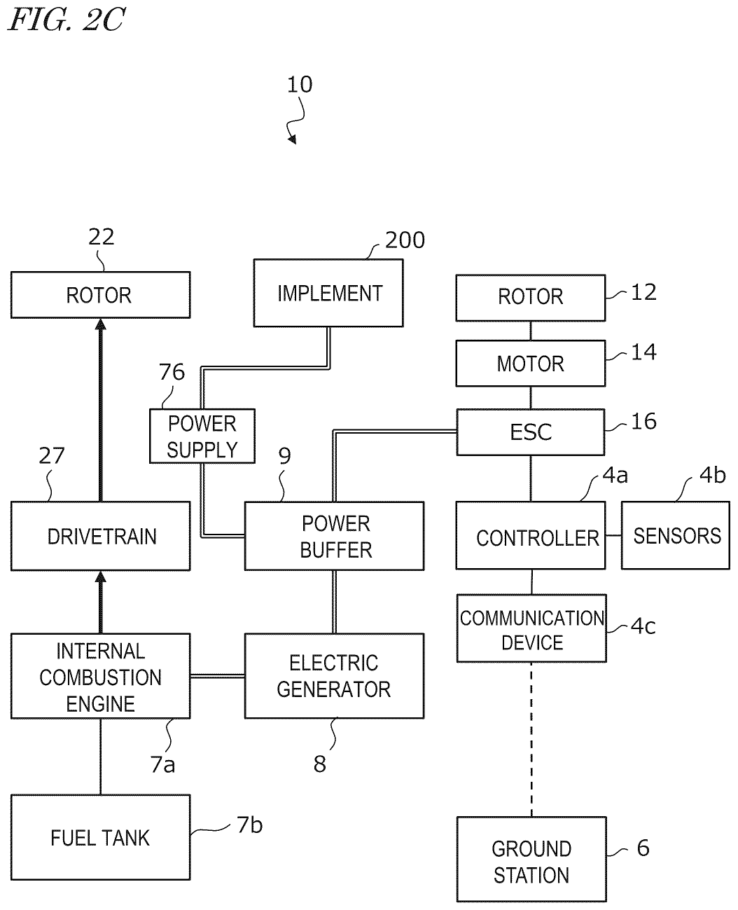

FIG. 2A shows a block diagram of a basic configuration example of a battery-driven multicopter 10. The battery-driven multicopter 10 includes a plurality of rotors 12, a plurality of motors 14, each driving a respective one of the plurality of rotors 12, a plurality of ESCs (Electric Speed Controllers) 16 each including a motor drive circuit that drives a respective one of the plurality of motors 14, a battery 52 that supplies power to each of the plurality of motors 14 through each respective ESC 16, a controller 4a configured or programmed to control a plurality of ESCs 16 to control attitude while flying, sensors 4b, a communication device 4c, and a power supply 76 that is electrically connected to the battery 52. In FIG. 2A, for simplicity, the rotor 12, the motor 14, and the ESC 16 are each shown by a single block, but the numbers of rotors 12, motors 14, and ESCs 16 are each plural. This also applies to FIGS. 2B and 2C. The ESC 16 may be included in the controller 4a.

The controller 4a may be configured or programmed to receive control commands wirelessly from, for example, a ground station 6 on the ground through the communication device 4c. The number of ground stations 6 is not limited to one, and the grand station 6 may be distributed across a plurality of locations. The communication device 4c may also wirelessly receive control commands from an operator's controller on the ground. The controller 4a may have functions to automatically or autonomously execute takeoff, flight, obstacle avoidance, and landing operations based on sensor data obtained from the sensors 4b. The controller 4a may be configured or programmed to communicate with the implement 200 connected to the power supply 76 and obtain signals indicating the state of the implement 200. Additionally, the controller 4a may provide signals to control the operation of the implement 200. Furthermore, the implement 200 may generate signals to instruct the operation of multicopter 10 and transmit them to the controller 4a. Such communication between the controller 4a and the implement 200 may be conducted through wired or wireless methods or mechanisms.

FIG. 2B is a block diagram showing a basic configuration example of a series hybrid drive type multicopter 10. Like the battery-driven multicopter 10, the series hybrid drive type multicopter 10 includes a plurality of rotors 12, a plurality of motors 14, a plurality of ESCs 16, a controller 4a, sensors 4b, and a communication device 4c. The series hybrid drive type multicopter 10 shown in the figure further includes an internal combustion engine 7a, a fuel tank 7b that stores fuel for the internal combustion engine 7a, an electric generator 8 that is driven by the internal combustion engine 7a to generate electric power, a power buffer 9 that temporarily stores electric power generated by the electric generator 8, and a power supply 76 that is electrically connected to the power buffer 9. The power buffer 9 is, for example, a battery such as a secondary battery. Electric power generated by the electric generator 8 is supplied to the motors 14 through the power buffer 9 and the ESCs 16. Additionally, the electric power generated by the electric generator 8 may be supplied to the implement 200 through the power supply 76.

FIG. 2C is a block diagram showing a basic configuration example of a parallel hybrid drive type multicopter 10. Like the series hybrid drive type multicopter 10, the parallel hybrid drive type multicopter 10 includes a plurality of rotors 12, a plurality of motors 14, each driving a respective one of the plurality of rotors 12, a plurality of ESCs 16, a controller 4a, sensors 4b, a communication device 4c, an internal combustion engine 7a, a fuel tank 7b, an electric generator 8, a power buffer 9, and a power supply 76. The parallel hybrid drive type multicopter 10 further includes a drivetrain 27 that transmits driving force from the internal combustion engine 7a, and the rotor 22 that rotates upon the receiving driving force from the internal combustion engine 7a through the drivetrain 27. The rotor 12 and rotor 22 may be distinguished by calling one “first rotor” and the other “second rotor”. The number of rotors 22 connected to drivetrain 27 and rotated may be one or two or more.

In the parallel hybrid drive type multicopter 10, the internal combustion engine 7a not only drives the electric generator 8 to generate power, but also mechanically transmits energy to the rotor 22 to rotate the rotor 22. In contrast, in the series hybrid drive type multicopter 10, all rotors 12 are rotated by electric power generated by the electric generator 8. Therefore, in the series hybrid drive type multicopter 10, when the electric generator 8 is, for example, a fuel cell, the internal combustion engine 7a is not an essential component.

A multicopter may be required to fly within a predetermined range of altitude. For example, flight at a height exceeding a certain height from the ground or water surface may be regulated by law. In Japan, flight in areas (airspace) at a height of 150 meters or more from the ground (or land surface) or water surface is regulated by the Civil Aeronautics Act. Hereinafter, the height from the ground (or land surface) or water surface may be referred to as “flight altitude”.

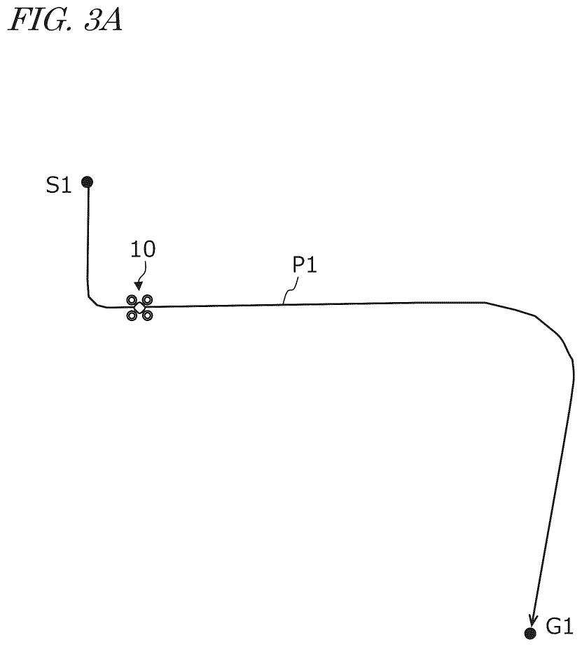

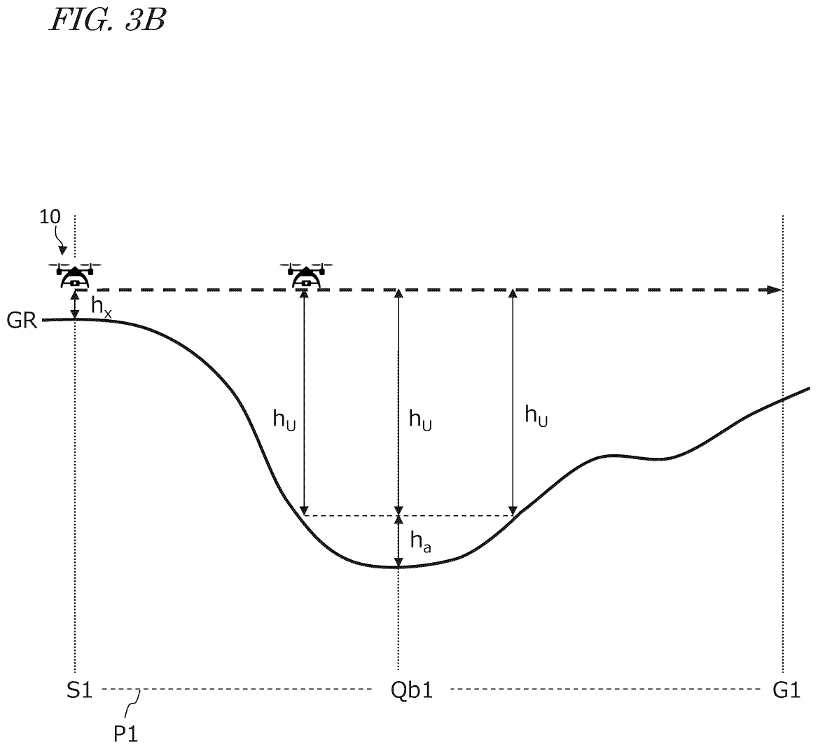

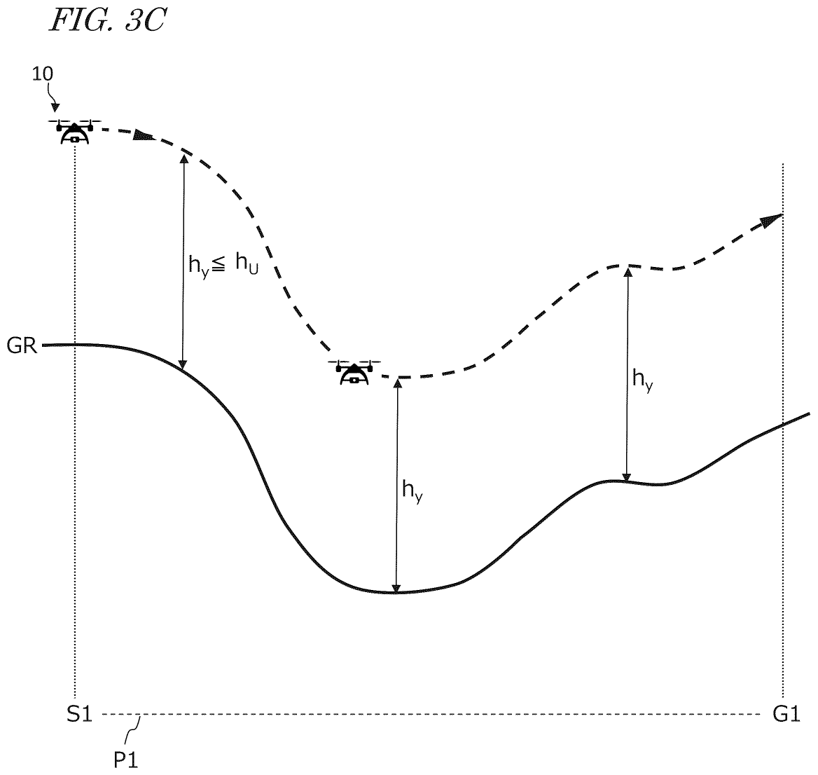

FIG. 3A schematically shows an example of a flight path of a multicopter 10 on a two-dimensional map (i.e., a two-dimensional flight path). As shown in FIG. 3A, when the multicopter 10 flies along the two-dimensional flight path P1 (hereinafter, may be simply referred to as “flight path P1”) from point S1 to point G1, it might be considered, for example, to move the multicopter 10 horizontally along the flight path P1, as shown in FIG. 3B. However, as shown in FIG. 3B, when there are large variations in elevation along the flight path P1, if the multicopter 10 is moved horizontally, even if the flight altitude (i.e., height from the ground GR) hₓ at the start point S1 of flight path P1 is set not to exceed a predetermined altitude h_{U} (i.e., hₓ≤h_{U}), there may be cases where the flight altitude exceeds the predetermined altitude h_{U} along the flight path P1. Elevation is the height from the geoid surface (simply referred to as “geoid”) or from the mean sea level to the ground (or land surface) at each point on the map. In the example of FIG. 3B, the height from the ground GR takes its maximum value at point Qb1, which is the point of lowest elevation along the flight path P1. The height from the ground GR at point Qb1 is h_{U}+hₐ, which exceeds the predetermined altitude h_{U}.

Therefore, as shown in the example of FIG. 3C, it might be considered to fly the multicopter 10 while maintaining a constant height from the ground GR. When the multicopter 10 flies along the flight path P1 with significant elevation variations, if the flight altitude is maintained at an altitude h_{y} that does not exceed the predetermined altitude h_{U} (i.e., h_{y}≤h_{U}), the multicopter 10 needs to move vertically (i.e., descend or ascend) in accordance with changes in the elevation of the ground GR. When a multicopter flies along a two-dimensional flight path, moving vertically as well as horizontally may increase the required driving energy compared to moving only horizontally. From the perspective of reducing or minimizing the increase in driving energy of the multicopter required for the flight, it is preferable to reduce or minimize vertical movement as much as possible.

The flight path generation system according to the example embodiment of the present disclosure described below allows the multicopter to fly within a predetermined altitude range while reducing or minimizing the increase in driving energy of the multicopter required for the flight. The flight path generation system according to the present example embodiment of the present disclosure enables efficient control of the flight of the multicopter.

The flight path generation system according to an example embodiment of the present disclosure generates a three-dimensional flight path for multicopter 10. The three-dimensional flight path includes at least a two-dimensional flight path shown on a two-dimensional map and the flight altitude at each point along the two-dimensional flight path. The flight path generation system includes an acquisition device that acquires route data including information of the two-dimensional flight path and map data including information of elevation at each point on the two-dimensional flight path, and a processor configured or programmed to generate the three-dimensional flight path by determining the flight altitude of the multicopter 10 on the two-dimensional flight path based on the two-dimensional flight path and the elevation.

The two-dimensional flight path is typically defined by a group of waypoints, each containing information of latitude and longitude, and the route data may include such a group of waypoints. The processor may be configured or programmed to determine, for example, the flight altitude at each waypoint, based on the two-dimensional flight path and elevation. The route data may include information about the three-dimensional flight path. That is, each waypoint included in the route data may further have information of the flight altitude. In that case, the processor can update the flight altitude at each waypoint.

The map data may be GIS data including elevation data in compliance with a geographic information system (GIS). An example of the data model for the map data is the Digital Elevation Model (DEM), which is classified as a raster data format. The DEM represents the height from the geoid to the ground with ground features such as buildings or trees removed.

The acquisition device in the flight path generation system according to an example embodiment of the present disclosure is, for example, the communication device 4c mentioned earlier. The acquisition device is configured or programmed to acquire route data including information of a predetermined two-dimensional flight path from, for example, a cloud server. Additionally, the acquisition device is configured or programmed to access a cloud server that manages map data via a network to acquire the map data. The acquisition device may be further configured or programmed to store the acquired route data and map data in a storage device. The storage device may be, for example, a semiconductor memory, magnetic storage device, or optical storage device, or a combination thereof. The processor may store the once-acquired route data and map data in the storage device in advance and update them after a predetermined period. The timing and frequency of the acquisition device acquiring route data and map data may be arbitrary, and may be, for example, at the power-up of the multicopter 10, or during the flight of the multicopter 10.

The processor in the flight path generation system according to an example embodiment of the present disclosure is a device including one or more semiconductor integrated circuits (e.g., processors).

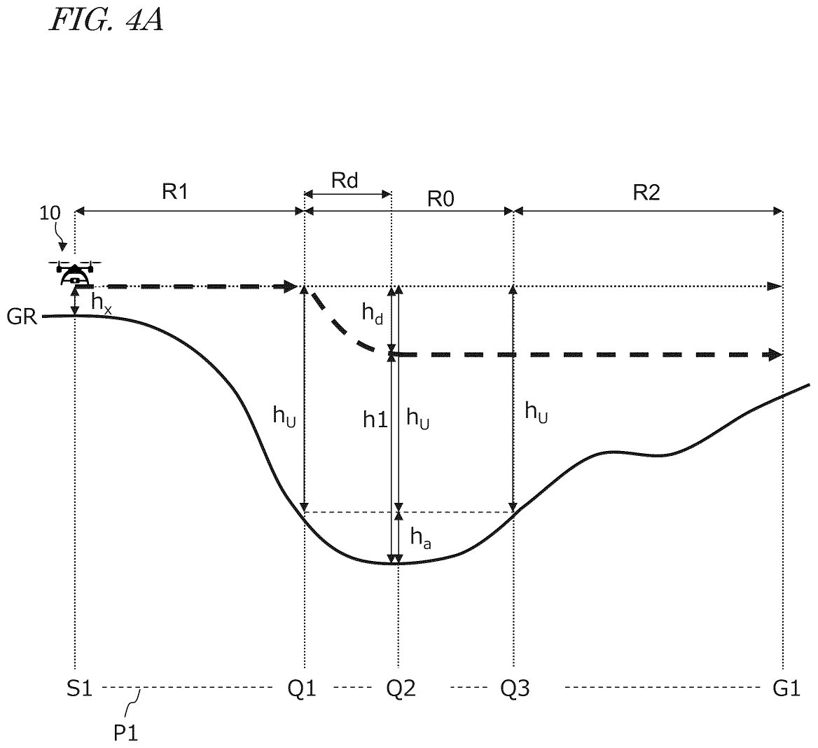

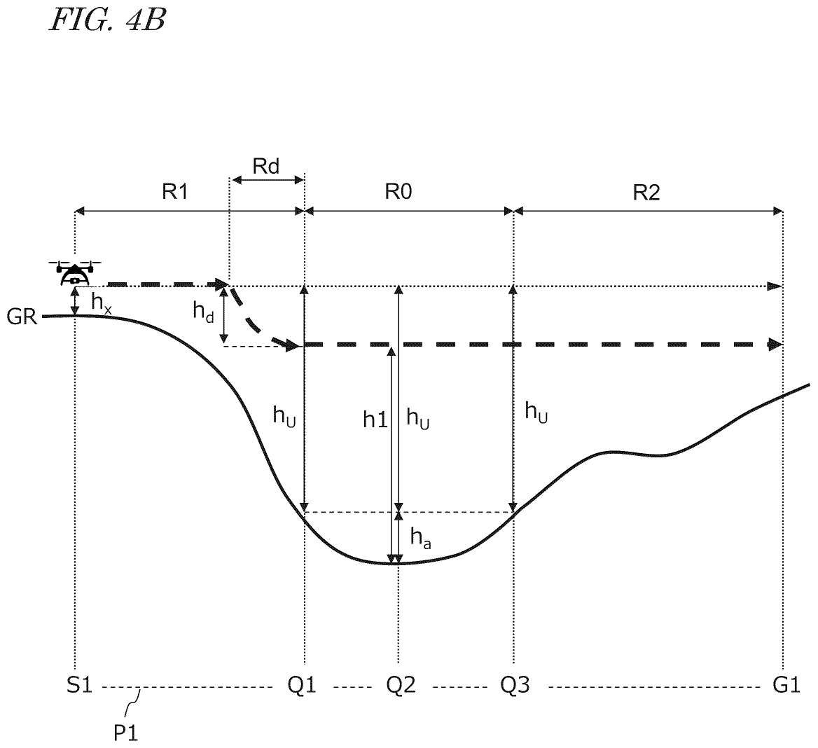

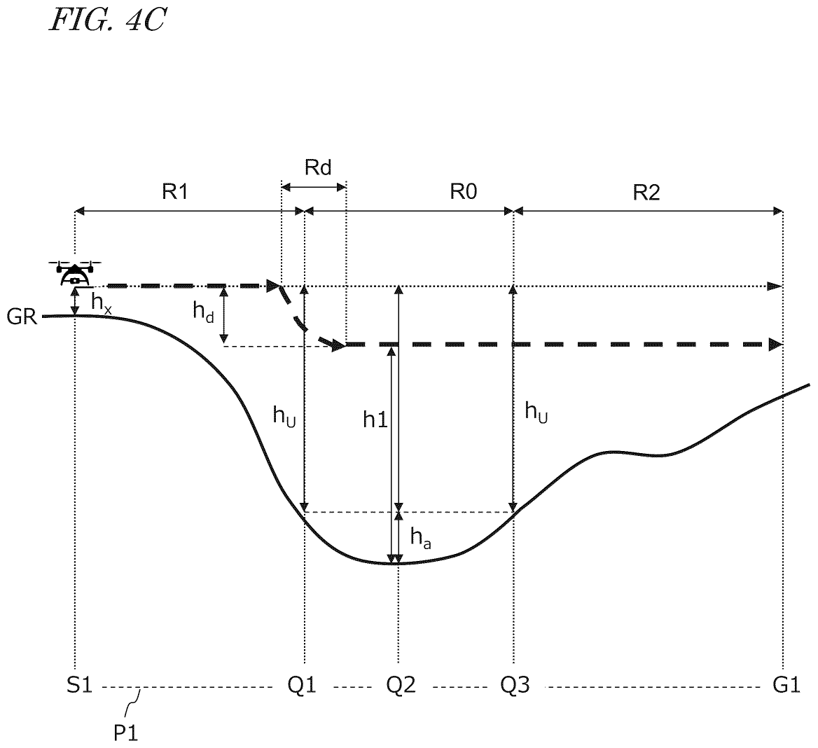

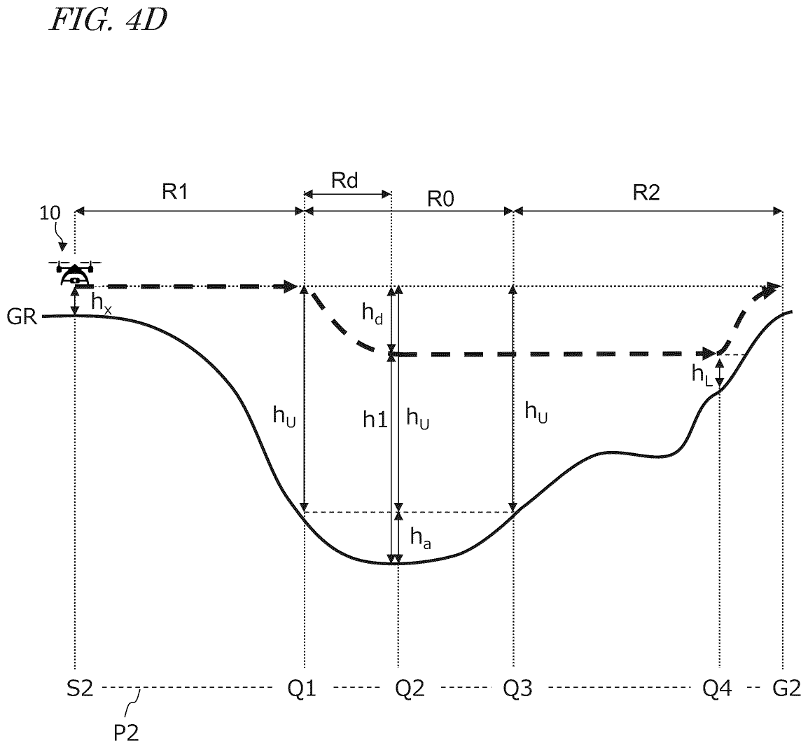

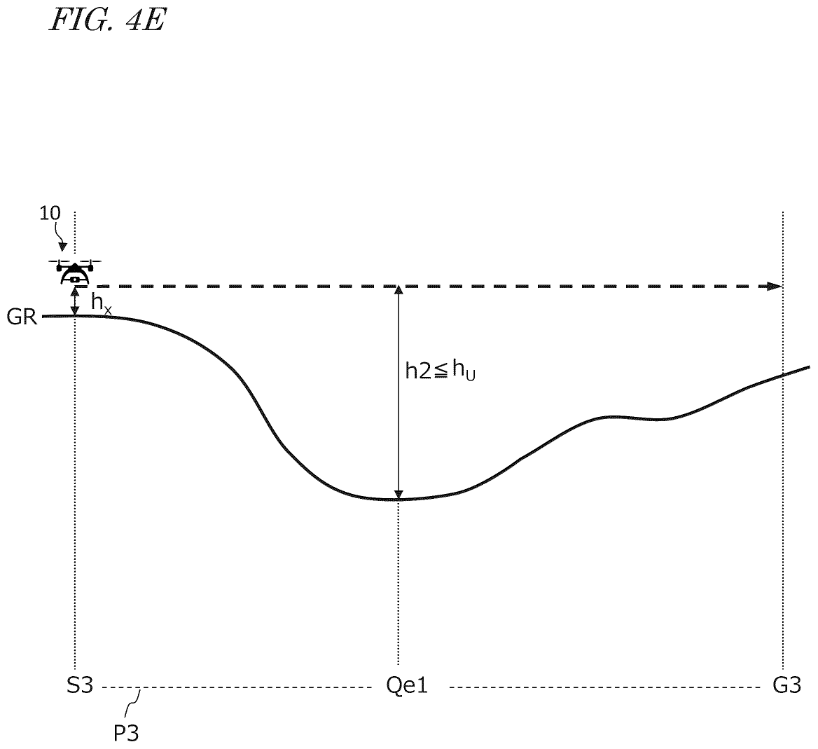

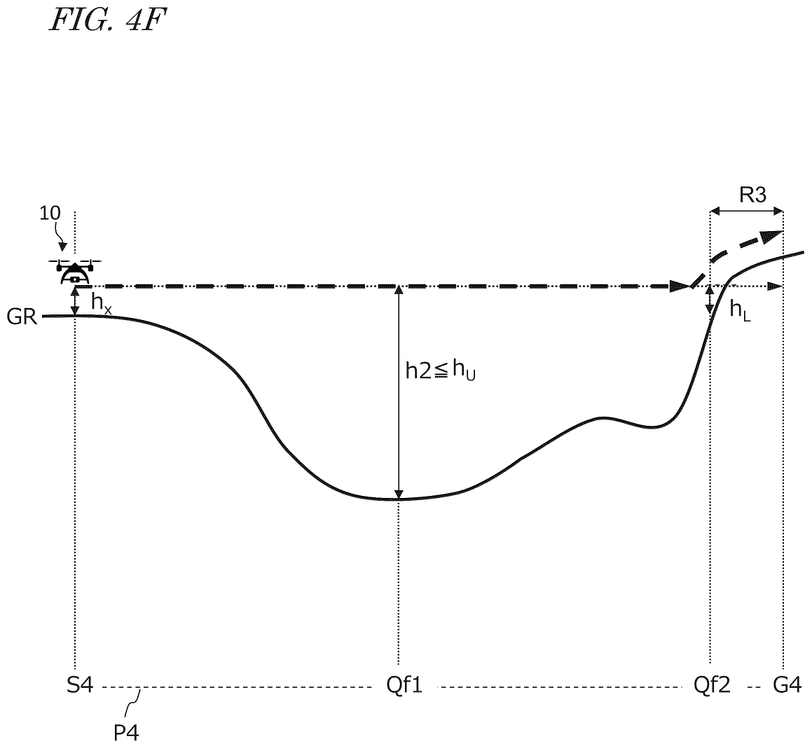

Referring to FIGS. 4A, 4B, and 4C, an example of processing performed by the processor in the flight path generation system according to this example embodiment will be explained. FIGS. 4A, 4B, and 4C are diagrams schematically showing examples of the multicopter 10 flying along the flight path P1 using the flight path generation system according to this example embodiment. The dashed arrows in FIGS. 4A, 4B, and 4C schematically show how the multicopter 10 flies.

First, referring to FIG. 4A, assuming that the multicopter 10 moves horizontally along the flight path P1 (dotted arrow in FIG. 4A), if an excess region RO where the flight altitude (i.e., height from the ground GR) of the multicopter 10 exceeds a predetermined altitude (may be referred to as “first predetermined altitude”) h_{U} and a first region R1 where the flight altitude does not exceed the predetermined altitude h_{U} occur on the flight path P1, the first region R1 leading to the excess region R0, the processor is configured or programmed to determine the flight altitude in the excess region R0 and the first region R1 as follows. The processor is configured or programmed to determine the flight altitude in the excess region R0 and the first region R1 such that (i) the maximum value of the flight altitude in the excess region R0 does not exceed the predetermined altitude h_{U}, (ii) the multicopter 10 descends in a descent region Rd including a portion of the excess region R0 or the first region R1, and (iii) the multicopter 10 moves horizontally across regions other than the descent region Rd in the excess region R0 and the first region R1. In the example of FIG. 4A, the maximum value h1 of the flight altitude in the excess region R0 is equal to or less than the predetermined altitude h_{U} (i.e., h1≤h_{U}). In the example of FIG. 4A, the descent region Rd is part of the excess region R0 and does not include the first region R1.

Note that in this specification, a “region” of a two-dimensional flight path refers to at least a range of part of the two-dimensional flight path and is not limited to an area extended two-dimensionally. The multicopter 10 flies along the flight path P1 in the order of the first region R1 and the excess region R0. In this example, the excess region R0 is continuously followed by the first region R1. In the illustrated example, the first region R1 is the range from the point S1 to the point Q1, and the excess region R0 is the range from the point Q1 to the point Q3.

According to the flight path generation system of the present example embodiment, since the vertical movement of the multicopter 10 can be suppressed, the increase in required driving energy can be suppressed.

The processor, assuming that the multicopter 10 moves horizontally along the flight path P1 (dotted arrow in FIG. 4A), sets the flight altitude hₓ at the start point S1 of the flight path P1 such that it does not exceed the predetermined altitude h_{U} (i.e., hₓ≤h_{U}). By moving the multicopter 10 horizontally along the flight path P1 from the start point S1 and beginning to descend at the same time as reaching the excess region R0, or as shown in the examples of FIGS. 4B and 4C, before the multicopter 10 reaches the excess region R0, it is possible to ensure that the flight altitude in the excess region R0 does not exceed the predetermined altitude h_{U}. By reducing or minimizing the distance that the multicopter 10 moves vertically as much as possible, the increase in required driving energy can be suppressed. The distance h_{d} that the multicopter 10 moves vertically in the descent region Rd is equal to or greater than the difference hₐ between the maximum value and the minimum value of elevations in the excess region R0. When the maximum value h1 of the flight altitude in the excess region R0 is equal to the predetermined altitude h_{U} (h1=h_{U}), then h_{d}=hₐ. The difference ha between the maximum value and the minimum value of elevations in the excess region R0 is the difference in elevation between the point Q2, which has the lowest elevation in the excess region R0, and the points Q1 and Q3, which have the highest elevations in the excess region R0. The processor is configured or programmed to determine, for example, the flight altitude in the excess region R0 such that the flight altitude at the point Q2 reaches h1 by having the multicopter 10 descend in the descent region Rd.

In the example shown in FIG. 4A, assuming that the multicopter 10 moves horizontally along the flight path P1 (dotted arrow in FIG. 4A), a second region R2 where the flight altitude does not exceed the predetermined altitude h_{U} further occurs on the flight path P1, the second region R2 following the excess region R0. In this case, the processor is configured or programmed to determine the flight altitude in the second region R2 such that the multicopter 10 moves horizontally across the second region R2. In this example, the multicopter 10 moves horizontally from regions other than the descent region Rd in the excess region R0 to the second region R2.

Referring to FIGS. 4B and 4C, other examples of processing performed by the flight path generation system will be explained.

The example shown in FIG. 4B differs from the example in FIG. 4A in that the descent region Rd is a portion of the first region R1 and does not include the excess region R0. The example shown in FIG. 4C differs from the example in FIG. 4A in that the descent region Rd includes a portion of the excess region R0 and a portion of the first region R1. In the examples of FIGS. 4B and 4C, as in the example of FIG. 4A, the increase in required driving energy can be suppressed.

Referring to FIG. 4D, another example of processing performed by the flight path generation system will be explained. FIG. 4D is a diagram schematically showing an example of the multicopter 10 flying along a two-dimensional flight path P2 (hereinafter, may be simply referred to as “flight path P2”) from point S2 to point G2 using the flight path generation system. Explanations of matters common to FIG. 4A will be omitted.

In the example shown in FIG. 4D, the processor is configured or programmed to determine the flight altitude in the second region R2 such that the flight altitude of the multicopter 10 in the second region R2 is equal to or greater than a predetermined altitude (may be referred to as “second predetermined altitude”) h_{L}, by making the multicopter 10 ascend in at least part of the second region R2. For example, the multicopter 10 is moved horizontally from the start point Q3 of the second region R2 and begins to ascend at the same time as reaching point Q4 where the flight altitude reaches the predetermined altitude h_{L}. Alternatively, the multicopter 10 may begin to ascend before reaching the point Q4. In this case as well, by reducing or minimizing the distance that the multicopter 10 moves vertically as much as possible, the increase in required driving energy can be suppressed.

Referring to FIG. 4E, another example of processing performed by the flight path generation system will be explained. FIG. 4E is a diagram schematically showing an example of the multicopter 10 flying along a two-dimensional flight path P3 (hereinafter, may be simply referred to as “flight path P3”) from point S3 to point G3 using the flight path generation system. Explanations of matters common to FIG. 4A will be omitted.

As shown in the example of FIG. 4E, assuming that the multicopter 10 moves horizontally along the flight path P3, if no region where the flight altitude exceeds the predetermined altitude h_{U} occurs on the flight path P3, the processor is configured or programmed to determine the flight altitude on the flight path P3 such that the multicopter 10 moves horizontally along the flight path P3. The maximum value of the flight altitude of the multicopter 10 along the flight path P3 is the flight altitude h2 at point Qe1 (h2≤h_{U}).

Referring to FIG. 4F, another example of processing performed by the flight path generation system will be explained. FIG. 4F is a diagram schematically showing an example of the multicopter 10 flying along a two-dimensional flight path P4 (hereinafter, may be simply referred to as “flight path P4”) from point S4 to point G4 using the flight path generation system. Explanations of matters common to FIG. 4E will be omitted.

In the example shown in FIG. 4F, the processor is configured or programmed to determine the flight altitude along the flight path P4 such that the flight altitude over the entire flight path P4 is equal to or greater than the predetermined altitude h_{L}. Assuming that the multicopter 10 moves horizontally along the flight path P4, if a third region R3 where the flight altitude of the multicopter 10 is less than the predetermined altitude h_{L} occurs on the flight path P4, the processor is configured or programmed to determine the flight altitude in the third region R3 such that the flight altitude of the multicopter 10 in the third region R3 is equal to or greater than the predetermined altitude h_{L}. For example, the multicopter 10 is moved horizontally from the start point S4 and begins to ascend before reaching the start point Qf2 of the third region R3. Alternatively, the multicopter 10 may begin to ascend at the same time as reaching the start point Qf2 of the third region R3. Note that in the example of FIG. 4F, assuming that the multicopter 10 moves horizontally along the flight path P4 (dotted arrow in FIG. 4F), no region where the flight altitude exceeds the predetermined altitude h_{U} occurs on the flight path P4. The maximum value of the flight altitude of the multicopter 10 along the flight path P4 is the flight altitude h2 at point Qf1 (h2≤h_{U}).

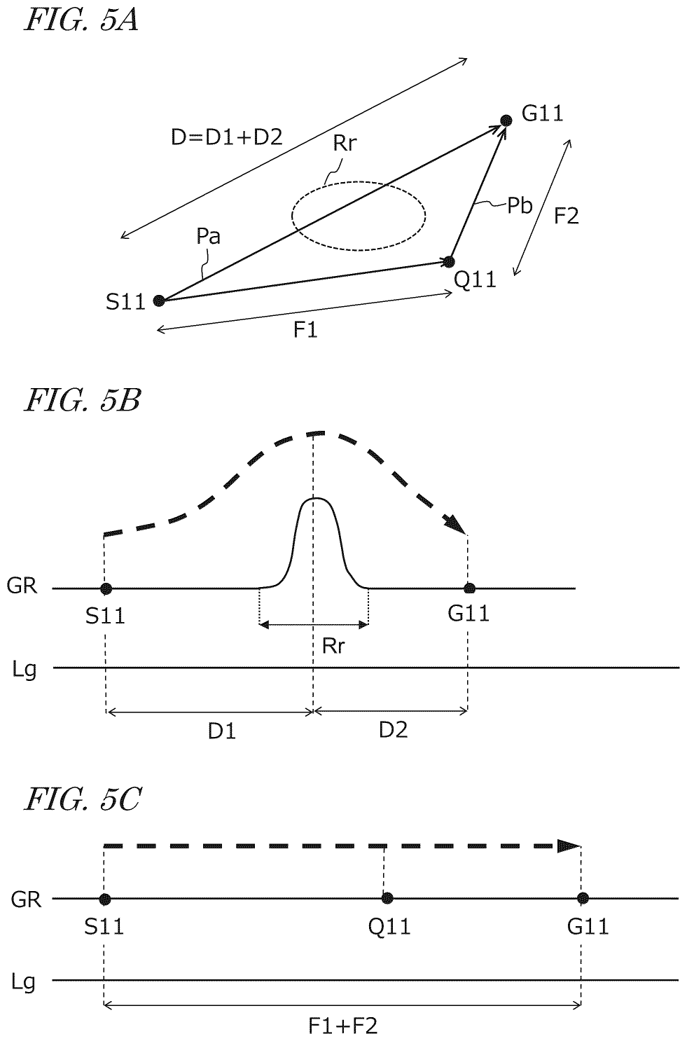

As explained with reference to FIGS. 5A, 5B, and 5C, the processor can update the flight path based on the acquired flight path and elevation. FIG. 5A is a diagram schematically showing an example of a flight path on a two-dimensional map from a start point S11 to a goal point G11. FIG. 5A shows two-dimensional flight paths Pa and Pb (hereinafter, may be simply referred to as “flight path Pa” and “flight path Pb”, respectively). FIGS. 5B and 5C are diagrams schematically showing the vertical movement of the multicopter 10 when flying along flight paths Pa and Pb, respectively. FIGS. 5B and 5C show the ground GR and a line Lg corresponding to the geoid or mean sea level.

As shown in FIG. 5A, there is a region Rr with higher elevation than the surrounding area between the start point S11 and the goal point G11. The flight path Pa is a path that connects the start point S11 and the goal point G11 with the shortest distance on a two-dimensional map. Since flight path Pa overlaps with the region Rr, when the multicopter 10 flies along the flight path Pa, it needs to move vertically as shown in FIG. 5B. The flight path Pb is a path that connects the start point S11 and the goal point G11 while avoiding the region Rr. The flight path Pb passes through point Q11 between the start point S11 and the goal point G11. When the multicopter 10 flies along the flight path Pb, as shown in FIG. 5C, it can reach the goal point G11 from the start point S11 by moving horizontally without moving vertically. Although the distance F1+F2 of the flight path Pb on the plane is longer than the distance D (D=D1+D2) of the flight path Pa on the plane, the driving energy required to fly along the flight path Pb may be less than the driving energy required to fly along the flight path Pa.

The processor may be configured or programmed to update the flight path in a plurality of modes, including, for example, a first mode that prioritizes reducing the driving energy of the multicopter 10 when flying along the flight path, and a second mode that prioritizes shortening the planar distance of the flight path. The mode for updating the flight path may be selected by the user. The start point and goal point of the flight path may be set by the user. The user may further set points to be passed between the start point and goal point. By setting points to be passed, it is possible, for example, to set a flight path that avoids airspace where flight is prohibited. Alternatively, it is also possible to set a flight path that includes areas where flight should be prioritized.

The processor may be configured or programmed to, for example, calculate the distance that the multicopter 10 is capable of moving horizontally when flying along the flight path, and update the flight path based on the calculated distance. For example, in the first mode, the processor updates the flight path so that the distance that can be moved horizontally increases. Alternatively, the processor may calculate the driving energy of the multicopter 10 when flying along the flight path, and update the flight path based on the calculated driving energy. For example, in the first mode, the processor updates the flight path so that the driving energy decreases.

The calculation of driving energy may be performed, for example, as follows. If the driving energy per unit distance required for the multicopter 10 to move horizontally is α, and the driving energy per unit distance required to move vertically is β for ascent and γ for descent, then the driving energy required to fly along the flight path Pa shown in FIG. 5B is D1×β+D2×γ, and the driving energy required to fly along the flight path Pb shown in FIG. 5C is (F1+F2)×α. D1 and D2 are the lengths of the distances in the ascending region and the descending region of flight path Pb, respectively. Note that the method of calculating driving energy is not limited to this and may be appropriately corrected by further considering the flight conditions of the multicopter 10, wind direction and speed during the flight of the multicopter 10, flight altitude of the multicopter 10, acceleration during ascent or descent of the multicopter 10, rotational speed of rotor 2, shape and weight of the multicopter 10, etc. For example, the driving energy may be corrected considering that flight efficiency decreases as flight altitude increases due to decreased air pressure.

The controller 4a in the example embodiment of the present disclosure may be implemented by a digital computer system configured or programmed to execute the processes described above.

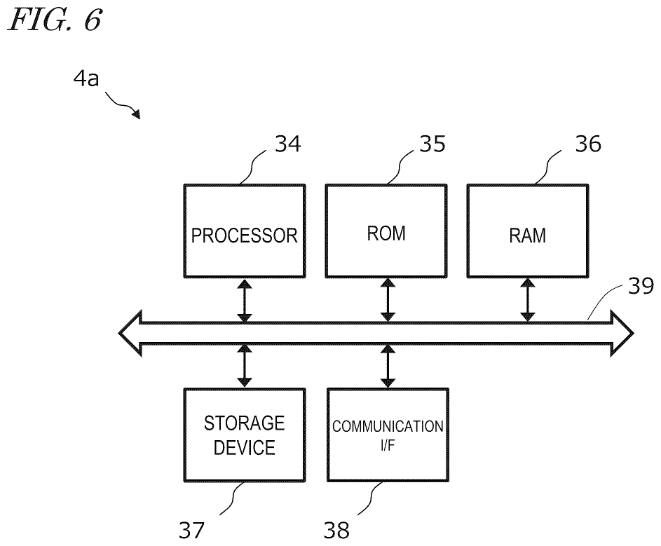

FIG. 6 is a block diagram showing an example of hardware configuration of the controller 4a. The controller 4a includes a processor 34, ROM (Read Only Memory) 35, RAM (Random Access Memory) 36, storage device 37, and communication I/F 38. These components are interconnected via a bus 39. The bus 39 is, for example, a CAN (Controller Area Network) bus.

The processor 34 may include one or more semiconductor integrated circuits (e.g., processors). The processor 34 sequentially executes computer programs stored in ROM 35 to implement the processes described above. The processor is also referred to as a central processing unit (CPU) or microprocessor. The processor is broadly interpreted to include terms such as FPGA (Field Programmable Gate Array) with CPU, GPU (Graphic Processor Unit), ASIC (Application Specific Integrated Circuit), or ASSP (Application Specific Standard Product).

The ROM 35 is, for example, a writable memory (for example, PROM), rewritable memory (for example, flash memory), or read-only memory. The ROM 35 stores programs that control the operation of the processor. The ROM 35 need not be a single recording medium but may be a collection of a plurality of recording media. Some of the plurality of collections may be removable memory.

The RAM 36 provides a work area for temporarily expanding programs stored in the ROM 35 during boot-up. The RAM 36 need not be a single recording medium but may be a collection of a plurality of recording media.

The communication I/F 38 is an interface for communication between the controller 4a and other electronic components or electronic control units (ECUs). For example, the communication I/F 38 may perform wired communication complying with various protocols. The communication I/F 38 may perform wireless communication complying with Bluetooth® standards and/or Wi-Fi@ standards. Both standards include wireless communication standards utilizing the 2.4 GHz frequency band.

The storage device 37 may be, for example, a semiconductor memory, magnetic storage device, or optical storage device, or a combination thereof. The storage device 37 is configured to store, for example, map data useful for autonomous flight of the multicopter 10, flight path data, and various sensor data acquired by the multicopter 10 during flight.

The processor 34 may be configured or programmed to function as the processor of the flight path generation system, and the storage device 37 may function as the storage device of the flight path generation system.

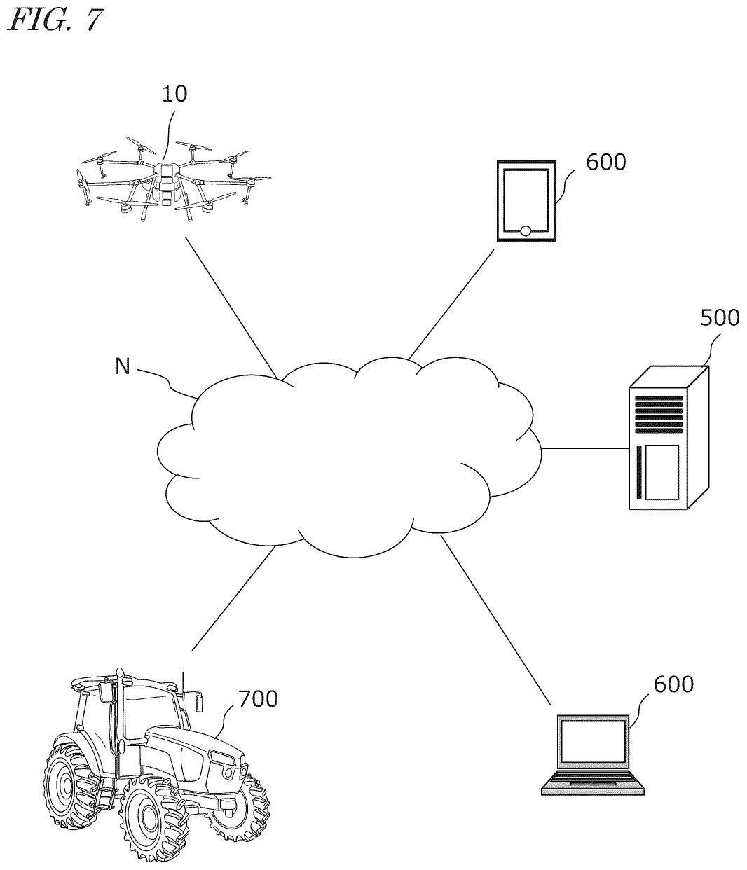

Note that, as mentioned earlier, the controller 4a may be configured or programmed to include, for example, a flight controller such as a flight controller and a higher-level computer (companion computer). The companion computer may be configured or programmed to execute each process necessary for flight path generation and provide flight-related commands based on the results of those processes to the flight controller or the flight path generation system. Additionally, some or all of the functions of electronic components or the flight path generation system mounted on the multicopter 10, such as the controller 4a, may be implemented by one or more servers (computers) 500 or terminal devices (including portable and fixed types) 600 connected to the communication device 4c of the multicopter 10 via a communication network N, as shown in FIG. 7. Agricultural machines 700 such as tractors may be connected to this communication network N, and communication may be performed between the multicopter 10 and the agricultural machines 700. Through the communication network N, some of the data used for processing by the controller 4a, and control signals for the multicopter 10 may be provided to the multicopter 10 from the agricultural machines 700.

Systems that provide various functions in the example embodiments can also be retrofitted to multicopters that do not have these functions. Such systems can be manufactured and sold independently of the multicopters. Computer programs used in such systems can also be manufactured and sold independently of the multicopters. Computer programs may be provided, for example, stored on non-transitory computer-readable storage media. Computer programs may also be provided through download via telecommunication lines (e.g., the Internet).

Unmanned aerial vehicles according to example embodiments of the present disclosure may be widely utilized not only for aerial photography, surveying, logistics, and agricultural chemical spraying applications but also for ground work related to agriculture, transportation of harvested crops and agricultural materials.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A flight path generation system for generating a three-dimensional flight path for an unmanned aerial vehicle, the flight path generation system comprising:
an acquisition device configured or programmed to acquire route data including information of a two-dimensional flight path of the unmanned aerial vehicle and map data including information of elevation at each point on the two-dimensional flight path; and
a processor configured or programmed to generate the three-dimensional flight path by determining a flight altitude of the unmanned aerial vehicle from a ground on the two-dimensional flight path based on the two-dimensional flight path and the elevation; wherein,
under an assumption that the two-dimensional flight path is traveled by the unmanned aerial vehicle moving horizontally, if an excess region where the flight altitude exceeds a predetermined first altitude and a first region where the flight altitude does not exceed the first predetermined altitude occur on the two-dimensional flight path, the first region leading to the excess region, the processor is configured or programmed to determine the flight altitude in the excess region and the first region such that:
a maximum value of the flight altitude of the unmanned aerial vehicle in the excess region does not exceed the first predetermined altitude;
the unmanned aerial vehicle descends in a descent region including a portion of the excess region or the first region; and
the unmanned aerial vehicle moves horizontally over regions other than the descent region in the excess region and the first region.

2. The flight path generation system according to claim 1, wherein the processor is configured or programmed to determine the flight altitude in the excess region and the first region such that the descent region is part of the excess region and does not include the first region.

3. The flight path generation system according to claim 1, wherein the processor is configured or programmed to determine the flight altitude in the excess region and the first region such that the descent region is part of the first region and does not include the excess region.

4. The flight path generation system according to claim 1, wherein the processor is configured or programmed to determine the flight altitude in the excess region and the first region such that the descent region includes part of the excess region and part of the first region.

5. The flight path generation system according to claim 1, wherein the processor is configured or programmed to determine the flight altitude in the excess region and the first region such that a distance that the unmanned aerial vehicle moves vertically in the descent region is equal to or less than a difference between a maximum value and a minimum value of elevations in the excess region.

6. The flight path generation system according to claim 1, wherein
when a second region where the flight altitude does not exceed the first predetermined altitude further occurs on the two-dimensional flight path under the aforesaid assumption, the second region following the excess region, the processor is configured or programmed to determine the flight altitude in the second region such that the unmanned aerial vehicle moves horizontally across the second region.

7. The flight path generation system according to claim 1, wherein
when a second region where the flight altitude does not exceed the first predetermined altitude further occurs on the two-dimensional flight path under the aforesaid assumption, the second region following the excess region, the processor is configured or programmed to determine the flight altitude in the second region such that a minimum value of the flight altitude in the second region is equal to or greater than a predetermined second altitude, and the unmanned aerial vehicle ascends in at least part of the second region.

8. The flight path generation system according to claim 1, wherein, under the aforesaid assumption, the processor is configured or programmed to set the flight altitude at a start point of the two-dimensional flight path so as not to exceed the first predetermined altitude.

9. The flight path generation system according to claim 1, wherein
when no region where the flight altitude exceeds the first predetermined altitude occurs on the two-dimensional flight path under the aforesaid assumption, the processor is configured or programmed to determine the flight altitude on the two-dimensional flight path such that the unmanned aerial vehicle moves horizontally along the two-dimensional flight path.

10. The flight path generation system according to claim 1, wherein the processor is configured or programmed to determine the flight altitude on the two-dimensional flight path such that the flight altitude on the two-dimensional flight path is equal to or greater than a predetermined second altitude.

11. The flight path generation system according to claim 1, wherein the processor is configured or programmed to calculate a distance that the unmanned aerial vehicle is capable of moving horizontally when flying along the two-dimensional flight path, based on the two-dimensional flight path and the elevation, and update the two-dimensional flight path based on the calculated distance.

12. The flight path generation system according to claim 1, wherein the processor is configured or programmed to calculate driving energy of the unmanned aerial vehicle when flying along the two-dimensional flight path, based on the two-dimensional flight path and the elevation, and update the two-dimensional flight path based on the calculated driving energy.

13. The flight path generation system according to claim 1, wherein
the processor is configured or programmed to update the two-dimensional flight path in a plurality of modes including:
a first mode that prioritizes reducing driving energy of the unmanned aerial vehicle when flying along the two-dimensional flight path; and
a second mode that prioritizes shortening a distance of the two-dimensional flight path.

14. An unmanned aerial vehicle comprising:
a plurality of rotors; and
a controller configured or programmed to control flight of the unmanned aerial vehicle based on the three-dimensional flight path generated by the flight path generation system according to claim 1.

15. The unmanned aerial vehicle according to claim 14, further comprising the flight path generation system.

16. A method for generating a three-dimensional flight path for an unmanned aerial vehicle, the method comprising:
acquiring route data including information of a two-dimensional flight path of the unmanned aerial vehicle and map data including information of elevation at each point on the two-dimensional flight path; and
determining a flight altitude of the unmanned aerial vehicle from the ground on the two-dimensional flight path based on the two-dimensional flight path and the elevation; wherein
the determining the flight altitude includes:
under an assumption that the two-dimensional flight path is traveled by the unmanned aerial vehicle moving horizontally, if an excess region where the flight altitude exceeds a predetermined first altitude and a first region where the flight altitude does not exceed the first predetermined altitude occur on the two-dimensional flight path, the first region leading to the excess region, determining the flight altitude in the excess region and the first region such that:
a maximum value of the flight altitude of the unmanned aerial vehicle in the excess region does not exceed the first predetermined altitude;
the unmanned aerial vehicle descends in a descent region including a portion of the excess region or the first region; and
the unmanned aerial vehicle moves horizontally over regions other than the descent region in the excess region and the first region.
